(19) United States
(12) Patent Application Publication
(10) Pub. No.: US 2024/0085023 A1
(43) Pub. Date: Mar. 14, 2024

(54) PREMIXED COMBUSTION BURNER, FUEL INJECTOR, AND GAS TURBINE

(71) Applicant: MITSUBISHI HEAVY INDUSTRIES, LTD., Tokyo (JP)

(72) Inventors: Kiyoshi FUJIMOTO, Yokohama-shi (JP); Tomo KAWAKAMI, Yokohama-shi (JP); Kenji MIYAMOTO, Yokohama-shi (JP); Keisuke MIURA, Tokyo (JP); Shinichi FUKUBA, Tokyo (JP)

(21) Appl. No.: 18/270,305

(22) PCT Filed: Nov. 26, 2021
(86) PCT No.: PCT/JP2021/043486

§ 371 Date: Jun. 29, 2023

(30) Foreign Application Priority Data
Feb. 19, 2021 (JP) 2021-025565

(51) Int. Cl. F23R 3/28; F02C 7/22; F23R 3/30

(52) U.S. Cl. CPC F23R 3/286; F02C 7/22; F23R 3/30

(57) ABSTRACT

A premixed combustion burner including: an outer tube having an inlet opening on a first side in an axial direction and an outlet opening on a second side in the axial direction; an inner tube formed in a cylindrical shape extending in the axial direction and spaced inside the outer tube, and forming a film air flow path between the inner and outer tubes; and a strut extending inward from the inner wall surface of the outer tube and supporting the inner tube. An end of the inner tube on the first side is located further towards the second side than the outer tube inlet opening. An end of the inner tube on the second side is located further towards the first side than the outlet opening of the outer tube. The outer tube, the strut, and the inner tube are formed with a fuel injection flow path.

### TECHNICAL FIELD

The present disclosure relates to premixed combustion burner, a fuel jetting device, and a gas turbine.

Priority is claimed on Japanese Patent Application No. 2021-025565 filed on Feb. 19, 2021, the content of which is incorporated herein by reference.

### BACKGROUND ART

A technique of performing so-called premixed combustion in order to discharge and reduce nitrogen oxide in a combustor such as a gas turbine is known. A premixed combustion burner for a gas turbine that can suppress flashback in a flow channel when a high-reactivity fuel having a high combustion speed such as hydrogen is used is described in PTL 1. In the premixed combustion burner of PTL 1, after the fuel is flowed from a fuel plenum into an air flow of an in-pipe flow channel and is mixed, air flows from an air plenum to intersect the mixture.

### CITATION LIST

### Patent Literature

[PTL 1] Japanese Unexamined Patent Application Publication No. 2012-57929

### SUMMARY OF INVENTION

### Technical Problem

The flow speed of the mixture flowing in the in-pipe flow channel in the premixed combustion burner described in PTL 1 becomes slow in the vicinity of an in-pipe wall surface. On the other hand, as in PTL 1, in a case where the fuel is flowed in to intersect the air flow of the in-pipe flow channel, a fuel concentration in the vicinity of the in-pipe wall surface increases in some cases. For this reason, there is a possibility, in which the combustion speed of the fuel exceeds the flow speed in the vicinity of the in-pipe wall surface and flashback in which flame runs up the in-pipe flow channel occurs.

An object of the present disclosure is to provide a premixed combustion burner, a fuel jetting device, and a gas turbine that can suppress occurrence of flashback.

### Solution to Problem

According to an aspect of the present disclosure, in order to solve the problems, there is provided a premixed combustion burner including an outer pipe that has an inlet opening on a first side in an axial direction in which an axis extends and an outlet opening on a second side in the axial direction, an inner pipe that is formed in a tubular shape extending in the axial direction, that is disposed at an interval on an inner side of the outer pipe, and that form a film air flow channel, in which film air flows, between the outer pipe and the inner pipe, and a strut that extends inward from an inner wall surface of the outer pipe and that supports the inner pipe, in which an end portion of the inner pipe on the first side is disposed on the second side of the inlet opening of the outer pipe, an end portion of the inner pipe on the second side is disposed on the first side of the outlet opening of the outer pipe, and a fuel jetting flow channel, through which a fuel is jetted from an outer side of the outer pipe to an inner side of the inner pipe via an inside of the strut, is formed in the outer pipe, the strut, and the inner pipe.

### Advantageous Effects of Invention

According to the aspect, the occurrence of flashback can be prevented.

### BRIEF DESCRIPTION OF DRAWINGS

FIG. 1 is a sectional view schematically showing a configuration of a gas turbine according to a first embodiment of the present disclosure.

FIG. 2 is a sectional view of a combustor in the first embodiment of the invention.

FIG. 3 is a sectional view of a premixed combustion burner according to the first embodiment of the present disclosure,

FIG. 4 is a sectional view of a strut, which is taken along line IV-IV of FIG. 3.

FIG. 5 is a view of the premixed combustion burner, which is viewed from an axial direction.

FIG. 6 is a graph in which a vertical axis represents fuel concentrations at an inner wall surface of an inner pipe and an inner wall surface of an outer pipe on an axis downstream side of the inner pipe and a horizontal axis represents an axial position of the premixed combustion burner.

FIG. 7 is a sectional view corresponding to FIG. 3 of the premixed combustion burner to a second embodiment of the present disclosure.

FIG. 8 is a sectional view of a premixed combustion burner showing a first modification example of the embodiment of the present disclosure.

FIG. 9 is a sectional view of a premixed combustion burner showing a second modification example of the embodiment of the present disclosure.

### DESCRIPTION OF EMBODIMENTS

Hereinafter, embodiments of the present disclosure will be described based on the drawings.

### First Embodiment

<<Configuration of Gas Turbine>>

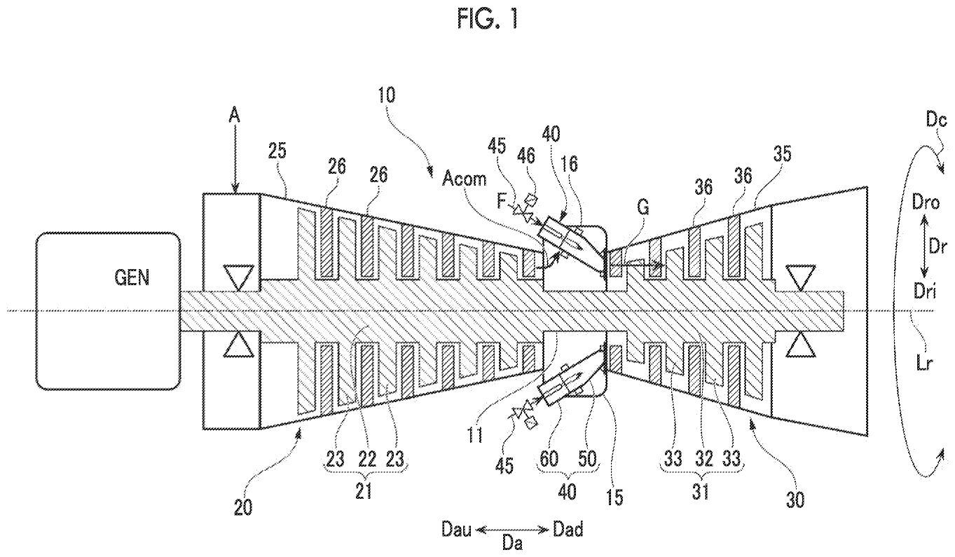

FIG. 1 is a sectional view schematically showing a configuration of a gas turbine according to a first embodiment of the present disclosure.

As shown in FIG. 1, a gas turbine 10 includes a compressor 20 that compresses air A, a plurality of combustors 40 that combusts a fuel in the air compressed by the compressor 20 to generate a combustion gas G, and a turbine 30 that is driven by the combustion gas G.

The compressor 20 has a compressor rotor 21 that rotates about a rotor axis Lr, a compressor casing 25 that rotatably covers the compressor rotor 21, and a plurality of stator vane rows 26. Hereinafter, a direction in which the rotor axis Lr extends will be referred to as a rotor axis direction Da, one side in the rotor axis direction Da will be referred to as an axis upstream side Dau, and the other side will be referred to as an axis downstream side Dad. In addition, a circumferential direction about the rotor axis Lr will be simply referred to as a circumferential direction DC, and direction perpendicular to the rotor axis Lr will be referred to as a radial direction Dr. Further, a side approaching the rotor axis Lr in the radial direction Dr will be referred to as a radial inner side Dri, and an opposite side thereto will be referred to as a radial outer side Dro.

The compressor rotor 21 has a rotor shaft 22 that extends in the rotor axis direction Da along the rotor axis Lr and a plurality of rotor vane rows 23 that are attached to the rotor shaft 22. The plurality of rotor Vane cows 23 are arranged in the rotor axis direction Da. Each of all the rotor vane rows 23 is configured by a plurality of rotor vanes arranged in the circumferential direction Dc. On the axis downstream side Dad of each of the plurality of rotor vane rows 23, any stator vane row 26 of the plurality of stator vane rows 26 is disposed. Each of the stator vane rows 26 is provided inside the compressor casing 25. Each of all the stator vane rows 26 is configured by a plurality of stator vanes arranged in the circumferential direction Dc. An annular space that is a region between the radial outer side Dro of the rotor shaft 22 and the radial inner side Dri of the compressor Casing 25 and in which the stator vanes and rotor the vanes are disposed in the rotor axis direction Da forms an air compression flow channel in which air flows while being compressed.

The turbine 30 is disposed on the axis downstream side Dad of the compressor 20. The turbine 30 has a turbine rotor 31 that rotates about the rotor axis Lr, a turbine casing 35 that rotatably covers the turbine rotor 31, and a plurality of stator vane rows 36. The turbine rotor 31 has a rotor shaft 32 that extends in the rotor axis direction Da along the rotor axis Lr and a plurality of rotor vane rows 33 that are attached to the rotor shaft 32. The plurality of rotor vane rows 33 are arranged in the rotor axis direction Da. Mach of all the rotor vane rows 33 is configured by a plurality of rotor vanes arranged in the circumferential direction Dc.

On the axis upstream side Dau of each of the plurality of rotor vane rows 33, any stator vane row 36 of the plurality of stator vane rows 36 is disposed. Each of the stator vane rows 36 is provided inside the turbine casing 35. Each of all the stator vane rows 36 is configured by a plurality of stator vanes arranged in the circumferential direction Dc. An annular space that is a region between the radial outer side Dro of the rotor shaft 32 and the radial inner side Dri of the turbine casing 35 and in which the stator vanes and the rotor vanes are disposed in the rotor axis direction Da forms a combustion gas flow channel in which the combustion gas G from the combustors 40 flows.

The compressor rotor 21 and the turbine rotor 31 are positioned on the same rotor axis Lr, are connected to each other, and form a gas turbine rotor 11. For example, a rotor of a generator GEN is connected to the gas turbine rotor 11. The gas turbine 10 further includes a tubular intermediate casing 16 about the rotor axis Lr.

The intermediate casing 16 is disposed between the compressor casing 25 and the turbine casing 35 in the rotor axis direction Da. The compressor casing 25 and the turbine casing 35 are connected to each other via the intermediate casing 16. The compressor casing 25, the intermediate casing 16, and the turbine casing 35 are connected to each other and form a gas turbine casing 15. Compressed air Acom from the compressor 20 flows into the intermediate casing 16. The plurality of combustors 40 are provided in the intermediate casing 16.

<<Configuration of Combustor>>

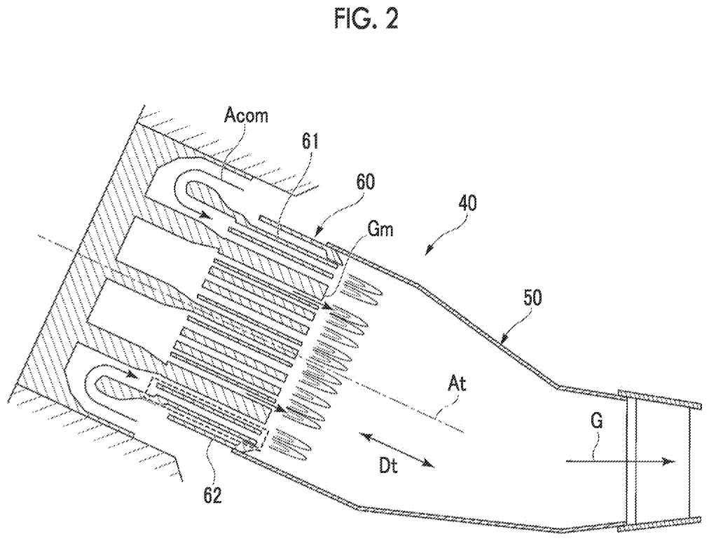

FIG. 2 is a sectional view of the combustor in the first embodiment of the invention. In FIG. 2, a detailed internal configuration of the combustor 40 is not shown.

As shown in FIG. 2, the combustor 40 has Combustion cylinder 50 and a fuel jetting device 60.

The combustion cylinder 50 generates the high-temperature and high-pressure combustion gas 3 by combusting a mixture Gm jetted from the fuel jetting device 60 (in other words, premixed combustion). Further, the combustion cylinder 50 sends the generated high-temperature and high-pressure combustion gas G into the combustion gas flow channel of the turbine 30. The combustion cylinder 50 of the first embodiment is disposed in the intermediate casing 16.

The fuel jetting device 60 mixes the compressed air Acom and a fuel F (see FIG. 1) with each other and jets the mixture Gm into the combustion cylinder 50. The fuel jetting device 60 includes & plurality of premixed combustion burners 61A, a casing 62, and a fuel plenum 63 (to be described later). As the fuel F of the combustor 40 of the first embodiment, hydrogen or the like, which is a high-reactivity fuel having a high combustion speed, can be used. Hereinafter, a direction in which an axis At of the combustor 40 extends will be referred to as a combustor axis direction Dt. The combustor 40 may further include a pilot burner (not shown).

<<Configuration of Premixed Combustion Burner>>

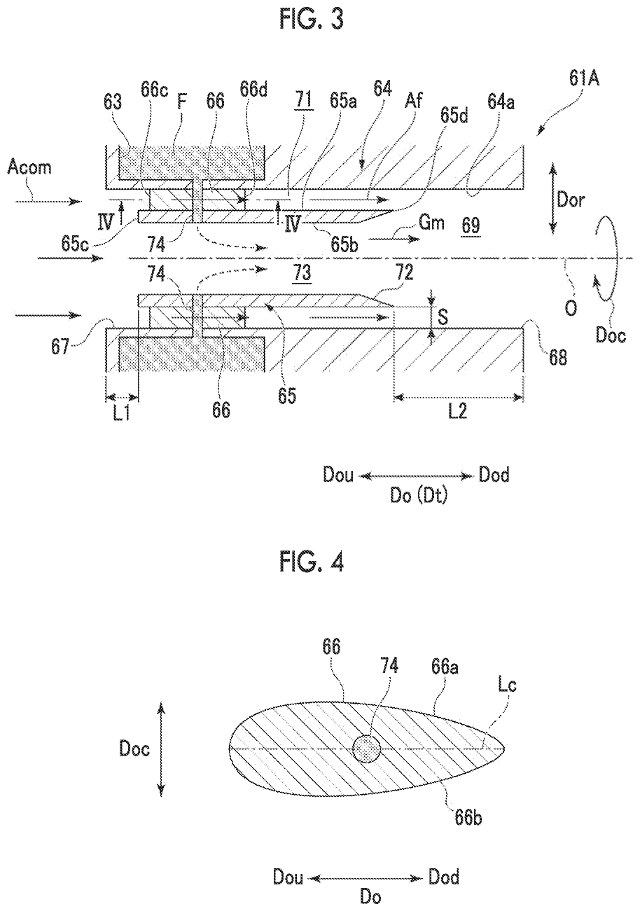

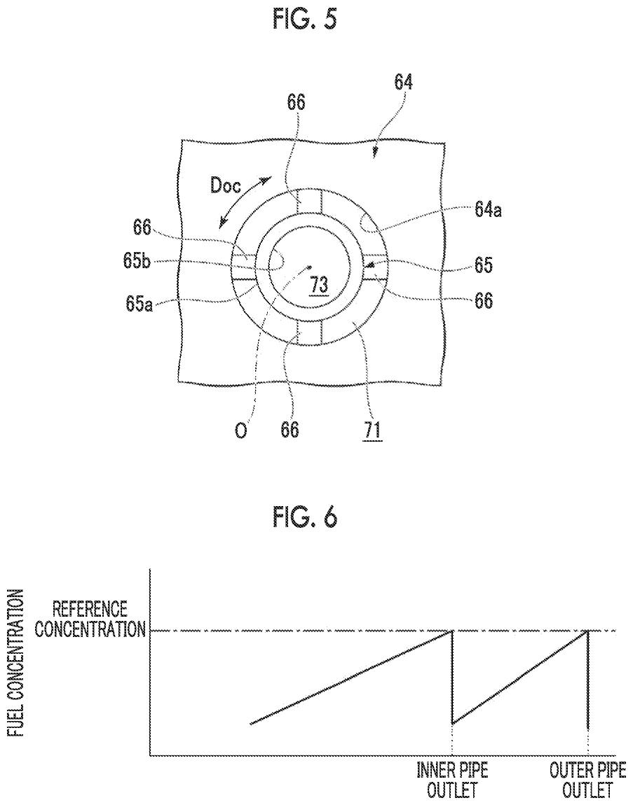

FIG. 3 is a sectional view of the premixed combustion burner according to the first embodiment of the present disclosure, and, for example, is an enlarged view of a portion surrounded by a broken line of FIG. 2. FIG. 4 is a sectional view of a strut, which is taken along line IV-IV of FIG. 3. FIG. 5 is a sectional view of the premixed combustion burner of FIG. 3, which is taken along line V-V. FIG. 5 is a view of the premixed combustion burner, which is viewed from the axial direction.

The premixed combustion burner 61A mixes the compressed air Acom supplied from the compressor 20 and the fuel F supplied from a fuel line 45 with each other. As shown in FIG. 3, the premixed combustion burner 61A includes an outer pipe 64, an inner pipe 65, and a strut 66.

As shown in FIGS. 2 and 3, the outer pipe 64 has an inlet opening 67 on an axis upstream side Dtu, which is a first side in the combustor axis direction Dt, and has an outlet opening 68 on an axis downstream side Dtd, which is a second side in the combustor is direction Dt. The outer pipe 64 of the first embodiment forms, on an inner side thereof, a cylindrical internal space 69 about a central axis O parallel to the axis At. Lengths of the outer pipes 64 of the plurality of premixed combustion burners 61A in the combustor axis direction Dt according to the first embodiment formed to be the same. Further, positions of the outer pipes 64 in the combustor axis direction Dt are the same. Hereinafter, a direction in which the central axis O of the internal space 69 of the outer pipe 64 extends will be referred to as an axial direction Do. In addition, a first side in the axial direction Do will be referred to as an axis upstream side Dou, and a second side will be referred to as an axis downstream side Dod. Further, a circumferential direction about the central axis O will be simply referred to as a circumferential direction Doc, and a direction perpendicular to the central axis O will be simply referred to as a radial direction Dor.

As shown in FIG. 3, the inner pipe 65 is disposed at an interval inside of each of the plurality of outer pipes 64. The inner pipe 65 is formed in a tubular shape extending in the axial direction Do. The inner pipe 65 forms a film air flow channel 71, in which film air Af flows, between the outer pipe 64 and the inner pipe 65. The inner pipe 65 exemplified in the first embodiment is formed in a cylindrical shape about the central axis O with a constant thickness dimension. Accordingly, between an outer peripheral surface 65a of the inner pipe 65 and an [symbol] of the outer pipe 64 in the first embodiment, the film air flow channel 71 having & constant dimension in the radial direction Dor is formed except for a location where the strut 66 is formed. For example, a dimension S of the film air flow channel 71 in the radial direction Dor can be approximately 10% of the inner diameter of the outer pipe 64.

An end portion 55c of the inner pipe 65 on the axis upstream side Dou is disposed on the axis downstream side Dod of the inlet opening 67 of the outer pipe 64. In addition, an end portion 65d of the inner pipe 65 on the axis downstream side Dod is disposed on the axis upstream side Dou of the outlet opening 68 of the outer pipe 64. In the pre mixed combustion burner 61A exemplified in the first embodiment, a distance L2 between the end portion 65d on the axis downstream side Dod and the outlet opening 68 is larger than a distance L1 between the end portion 65c on the axis upstream side Dou and the inlet opening 67 in the axial direction Do.

The inner pipe 65 of the first embodiment has a tapered surface 72 at the end portion 65d on the axis downstream side Dod. The tapered surface 72 is inclined such that a flow channel sectional area of an inner flow channel. 73 formed on an inner side of the inner pipe 65 in the radial direction Dor increases toward the axis downstream side Dod.

As shown in FIGS. 3 and 5, the strut 66 extends inward from the inner peripheral surface 64a of the outer pipe 64 and supports the inner pipe 65. In other words, the strut 66 is provided to cross the film air flow channel 71 in the radial direction Dor and connects the inner peripheral surface 64a of the outer pipe 64 and the outer peripheral surface 65a of the inner pipe 65 to each other. A plurality of struts 66 of the first embodiment are provided at intervals in the circumferential direction Doc. In FIG. 5, a case where four struts 66 are disposed at equal intervals in the circumferential direction Doc is given as an example.

As shown in FIG. 4, a sectional shape of the strut 66 is a vane shape. More specifically, the sectional shape of the strut 66 is a symmetric vane in which a first surface 66a that faces a first side in the circumferential direction Doc and a second surface 66b that faces a second side are symmetrically formed and a center axis Le in the circumferential direction Doc and a vane cord match each other. In addition, the center axis Lc of the symmetric vane extends in the axial direction Do. As the sectional shape of the strut 66 is a symmetric vane as described above, it can be suppressed that the strut 66 adds a swirling component to an air flow of the film air flow channel 71.

As shown in FIG. 3, the end portion 65c of the inner pipe 65 on the axis upstream side Dou according to the first embodiment extends further to the axis upstream side Dou than an and portion 66c, which is on the most axis upstream side Dou of the strut 66, does. In addition, an end portion 66d of the strut 66 on the axis downstream side Dod according to the first embodiment is disposed at a position closer to the end portion 66c on the axis upstream side Dou than the end portion 65d of the inner pipe 65 on the axis downstream side Dod.

As shown in FIG. 3, the fuel plenum 63 is provided in the casing 62 (see FIG. 2) and on an outer side of the outer pipe 64. The fuel line 45 (see FIG. 1) is connected to the fuel plenum 63, and the fuel F is supplied from the fuel line 45 to the fuel plenum 63. As shown in FIG. 1, the fuel line 45 is provided with a fuel flow rate regulating valve 46 that regulates the flow rate of the fuel F supplied to the fuel plenum 63. The fuel plenum 63 of the first embodiment is formed at least on an outer side of the strut 66 in the radial direction Dor.

A fuel jetting flow channel 74 is formed in the outer pipe 64, the strut 66, and the inner pipe 65. The fuel jetting flow channel 74 allows the fuel F from the Outer side of the outer pipe 64 to be jetted to the inner flow channel 73 on the inner side of the inner pipe 65 via the inside of the strut 66. More specifically, the fuel jetting flow channel 74 of the first embodiment penetrates the outer pipe 64, the strut 66, and the inner pipe 65 in the radial direction Dor. The fuel jetting flow channel 74 allows the fuel plenum 63 adjacent to the outer pipe 64 and the inner flow channel 73 of the inner pipe 65 to communicate with each other, and the fuel F of the fuel plenum 63 is jetted to the inner flow channel 73 of the inner pipe 65 through the fuel jetting flow channel 74 as shown by a broken line of FIG. 3. Herein, although a case where the fuel jetting flow channel 74 extends in the radial direction Dor has been described, a direction in which the fuel jetting flow channel 74 extends is not limited to the radial direction Dor. The direction in which the fuel jetting flow channel 74 extends may be a direction intersecting the central axis O in sectional view of FIG. 3.

<<Lengths of Outer Pipe and Inner Pipe>>

FIG. 6 is a graph in which a vertical axis represents fuel concentrations at the inner peripheral surface of the inner pipe and the inner peripheral surface of the outer pipe on the axis downstream side of the inner pipe and a horizontal axis represents an axial position of the premixed combustion burner.

The compressed air Acom flows from the axis upstream side Dou into the premixed combustion burners 61A. Specifically, the compressed air Acom flows from the inlet opening 67 of the outer pipe 64 and is diverted to the film air flow channel 71 positioned on an outer side of the inner pipe 65 and the inner flow channel 73 positioned on the inner side of the inner pipe 65. In this case, the compressed air Acom is diverted at each flow rate corresponding to a ratio (volumetric flow rate) between flow channel sectional areas of the film air flow channel 71 and the inner flow channel 73. Some of the compressed air Acom flowed into the film air flow channel 71 (in other words, the film air Af) flows in the film air flow channel 71 toward the axis downstream side Dod. On the other hand, the of the compressed air Acom flowed into the inner flow channel 73 (in other words, a main flow) is mixed with the fuel F jetted from the fuel jetting flow channel 74 and becomes the mixture Gm. The jetting of the fuel F in the first embodiment is a so-called crossflow jetted in a direction intersecting the flow of the inner flow channel 73.

In the vicinity of an [symbol] of the inner pipe 65 and the vicinity of the inner peripheral surface 64a of the outer pipe 64, a flow of which a flow speed decreases by coming into contact with each of the inner peripheral surfaces 64a and 65b and of which the flow speed falls below a combustion speed of the mixture Gm (in other words, a reaction speed of flame). Herein, the flow speed that falls below the combustion speed means, in a case of a flow of a combustible fluid, for example, a flow speed at which flame runs up to the upstream side of the flow. Hereinafter, a flow of which a flow speed decreases by coming in to contact with each of the inner peripheral surfaces 64a and 65b and of which a flow speed falls below the combustion speed of the mixture Gm will be simply referred to as a flow in contact with the inner peripheral surface 64a or a flow in contact with the inner peripheral surface 65b.

The fuel F jetted in the premixed combustion burner 61A is further mixed with the compressed air Acom as heading for the axis downstream side Dod, and the fuel concentration of a flow in contact with the inner peripheral surface 65b of the inner pipe 65 gradually rises as shown in FIG. 6. The length of the inner pipe 65 in the axial direction Do according the first embodiment is formed such that the fuel concentration of the flow in contact with the inner peripheral surface 65b of the inner pipe 65 is equal to or lower than a sufficiently low concentration having no possibility in which flame is maintained in an air flow (hereinafter, referred to as a reference concentration and indicated by a one-dot chain line in FIG. 6).

The mixture Gm that flowed out from the end portion 65d (an inner pipe outlet in FIG. 6) of the inner pipe 65 on the axis downstream side Dod to the axis downstream side Dod flows in a flow channel on the inner side of the outer pipe 64 (the internal space 69) toward the axis downstream side Dod. Herein, the film air Af flowed out from the film air flow channel 71 flows around the mixture Gm immediately after flowing out from the end portion 650 of the inner pipe 65. Then, as heading from the end portion 65d of the inner pipe 65 on the axis downstream side Dod in the axial direction Do toward the outlet opening 68 (an outer pipe outlet in FIG. 6) of the outer pipe 64, the fil air Af is mixed with the mixture Gm, and a fuel concentration thereof gradually rises. That is, the fuel concentration of a flow in contact with the inner peripheral surface 64a of the outer pipe 64 gradually rises as heading from the position of the end portion 65d (the inner pipe outlet in FIG. 6) on the axis downstream side Dod toward the axis downstream side Dod as shown in FIG. 6. The length of the outer pipe 64 in the axial direction Do according to the first embodiment is formed such that the fuel concentration of the flow in contact with the inner peripheral surface 64a of the outer pipe 64 is equal to or lower than the reference concentration.

<<Effects>>

The premixed combustion burner 61A of the first embodiment described above includes the outer pipe 64 that has the inlet opening 67 on the axis upstream side Dou and that has the outlet opening 68 on the axis downstream side Dod, the inner pipe 65 that is formed in a tubular shape extending in the axial direction Do, that is disposed at an interval on the inner side of the outer pipe 64, and that forms the film air flow channel 71, in which the film air Af flows, between the outer pipe 64 and the inner pipe 65, and the strut 66 that extends inward from the inner peripheral surface 64a of the outer pipe 64 and that supports the inner pipe 65. In addition, the end portion 65c of the inner pipe 65 on the axis stream side Dou is disposed on the axis downstream side Dod of the inlet opening 67 of the outer pipe 64, and the end portion 65d of the inner pipe 65 on the axis downstream side Dod is disposed on the axis upstream side Dou of the outlet opening 68 of the outer pipe 64. Further, the fuel jetting flow channel 74 that allows the fuel E to be jetted from the outer side of the outer pipe 64 to the inner side of the inner pipe 65 via the inside of the strut 66 is formed in the outer pipe 64, the strut 66, and the inner pipe 65.

With the premixed combustion burner 61A having such a configuration, the film air Af can flow along the inner peripheral surface 64a of the outer pipe 64, which is on the axis downstream side Dod of the inner pipe 65, as the inner pipe 65 is disposed on the inner side of the outer pipe 64 and forms the film air flow channel 71. Accordingly, it can be suppressed that the fuel concentration of a flow in contact with the inner peripheral surface 64a of the outer pipe 64 rises. Therefore, even in a case where the flow speed of the flow in contact with the inner peripheral surface 64a of the outer pipe 64 falls below the combustion speed, the occurrence of flashback in which flame runs up the flow in contact with the inner peripheral surface 64a of the outer pipe 64 can be suppressed.

Further, in the premixed combustion burner 61A, since the end portion. 65c of the inner pipe 65 on the axis upstream side Dou is disposed on the axis downstream side Dod of the inlet opening 67 of the outer pipe 64, the compressed air Acom can be stably diverted to the film air flow channel 71 and the inner flow channel 73 without disturbing the flow of the compressed air Acom flowed in from the inlet opening 67 of the outer pipe 64. In addition, since the end portion 65d of the inner pipe 65 on the axis downstream side Dod is disposed on the axis upstream side Dou of the outlet opening 68 of the outer pipe 64, it can be suppressed that flame runs up a flow in contact with the inner peripheral surface 65b of the inner pipe 65.

Further, in the premixed combustion burner 61A, since the fuel jetting flow channel 74 is formed Inside each of the outer pipe 64, the strut 66, and the inner pipe 65, the fuel F supplied to the fuel plenum 63 on the outer side of the outer pipe 64 or the like can be jetted from the inner peripheral surface 65b of the inner pipe 65 toward the inner channel 73 to be a crossflow. Therefore, the fuel jetting flow channel 74 can be formed by effectively using the inside of the strut 66 that supports the inner pipe 65 without forming a pipe dedicated for guiding the fuel jetting flow channel 74.

The outer pipe 64 of the premixed combustion burner 61A of the first embodiment described above is formed to have a length such that the fuel concentration of a flow in contact with the inner peripheral surface 64a of the outer pipe 64, among a flow from the inlet opening 67 to the outlet opening 68 via the film air flow channel 71, is a fuel concentration that is equal to or lower than the reference concentration.

Therefore, the fuel concentration of the flow in contact with the inner peripheral surface 64a of the outer pipe 64 is equal to or lower than the reference concentration, and it can be suppressed that the flow in contact with the inner peripheral surface 64a of the outer pipe 64 combusts. As a result, the occurrence of flashback in which flame runs up the flow in contact with the inner peripheral surface 64a of the outer pipe 64 can be suppressed.

In addition, the inner pipe 55 of the premixed combustion burner 61A of the first embodiment described above is formed to have a length such that the fuel concentration of a flow in contact with the inner peripheral surface 65b of the inner pipe 65, among a flow flowing out from the end portion 65d of the inner pipe 65 on the axis downstream side Dod, is a fuel concentration that is equal to or lower than the reference concentration.

Therefore, the fuel concentration of the flow in contact with the inner peripheral surface 65b of the inner pipe 65 is equal to or lower than the reference concentration, and it can be suppressed that the flow in contact with the inner peripheral surface 65b of the inner pipe 65 combusts. As a result, the occurrence of flashback in which flame runs up the flow in contact with the inner peripheral surface 65b of the inner pipe 65 can be suppressed.

Further, the strut 66 of the premixed combustion burner 61A of the first embodiment described above has a sectional vane shape.

Therefore, since a flow channel resistance of the film air Af flowing in the axial direction Do in the film air flow channel 71 can be reduced, a flow speed decrease of the film air Af can be suppressed.

In addition, the premixed combustion burner 61A of the first embodiment described above includes, at the end portion 65d of the inner pipe 65 on the axis downstream side Dod, the tapered surface 72 that is inclined such that the flow channel sectional area of the inner flow channel 73 increases toward the axis downstream side Dod.

Therefore, in a case where it is necessary to provide the tapered surface 72 at the end portion 65d on the axis downstream side Dod for convenience of preparing the inner pipe 65, the flow channel sectional area of the film air flow channel 71 increases, the static pressure of the film air Af is recovered, and a flow speed decrease can be suppressed.

Further, the premixed combustion burner 61A of the first embodiment described above includes a hydrogen gas as the fuel F.

With the premixed combustion burner 61A, even in a case where a high-reactivity fuel that contains the hydrogen gas as described above and that has a high combustion speed is used, the occurrence of flashback can be effectively suppressed.

Further, the fuel jetting device 60 of the first embodiment includes the plurality of premixed combustion burners 61A, the casing 62 that supports the premixed combustion burners 61A, and the fuel plenum 63 that is provided in the casing 62 and on the outer side of the outer pipe 64.

With the fuel jetting device 60, the occurrence of damage caused by flashback can be suppressed by including the premixed combustion burners 61A.

In addition, the gas turbine 10 of the first embodiment includes the compressor 20 that generates the compressed air Acom, the combustor 40 that has the fuel jetting device 60 and the combustion cylinder 50 which generates the combustion gas G by combusting the mixture Gm jetted from the fuel jetting device 60, and the turbine 30 that is driven by the combustion gas G generated by the combustor 40.

With such a gas turbine 10, the occurrence of damage to the combustor 40 is suppressed, and reliability of the gas turbine 10 can be improved.

### Second Embodiment

Next, a second embodiment of the present disclosure will be described based on the drawings. The second embodiment to be described below is different from the first embodiment described above in terms of only the configuration of the premixed combustion burner. For this reason, description will be made with the same portions as in the first embodiment assigned with the same reference signs, and redundant description will be omitted (the same applies to a first modification example and a second modification example to be described later).

<<Configuration of Premixed Combustion Burner>>

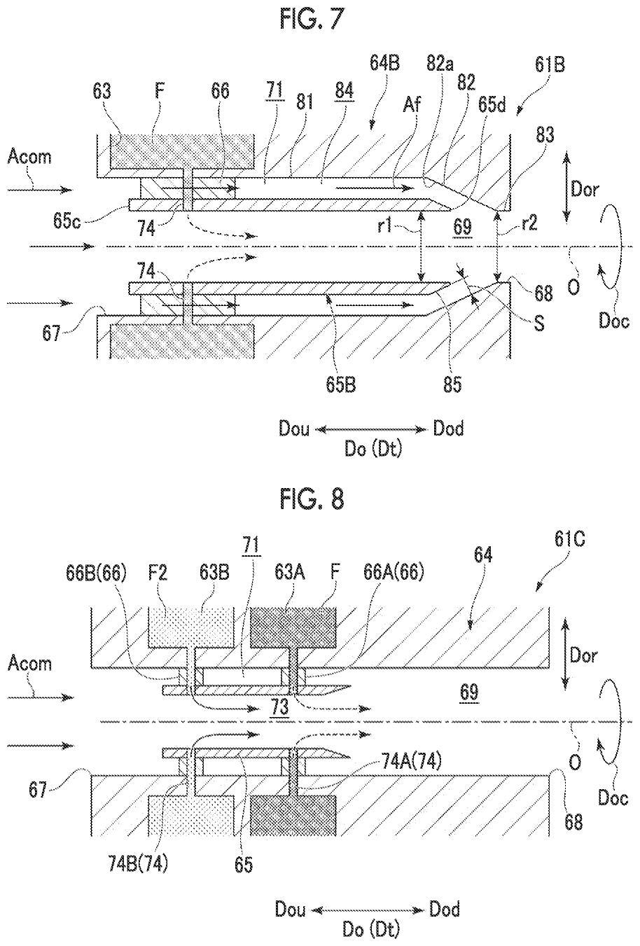

FIG. 7 is a sectional view corresponding to FIG. 3 of the premixed combustion burner according to the second embodiment of the present disclosure.

As shown in FIG. 7, a premixed combustion burner 61B of the second embodiment mixes the compressed air Acom supplied from the compressor 20 and the fuel F supplied from the fuel line 45 with each other. The premixed combustion burner 61B includes an outer pipe 64B, an inner pipe 65B, and the strut 66.

As in the first embodiment, the outer pipe 64B of the second embodiment has the inlet opening 67 on the axis upstream side Dou and has the outlet opening 68 on the axis downstream side Dod. The outer pipe 64B includes an outer pipe main body 81, an outlet sectional reduction portion 82, and an outlet end portion 83. The outer pipe main body 81 of the present embodiment forms a cylindrical internal space 84 about the central axis O parallel to the axis At on the inner side. The sectional shape of the internal space 84 of the outer pipe main body 81 is not limited to a circular shape.

The outlet sectional reduction portion 82 is formed on the axis downstream side Dod of the outer pipe main body 81. The outlet sectional reduction portion 82 gradually decreases the sectional area of the internal space 69 of the outer pipe 64B (in other words, a flow channel sectional area) toward the outlet opening 68. The outlet sectional reduction portion 82 of the second embodiment reduces the flow channel sectional area of the outer pipe 64B at a constant inclination angle to have an inner diameter r2 that is the same as an inner diameter r1 of the inner pipe 65B on the most axis downstream side Dod.

The outlet end portion 83 is formed on the axis downstream side Dod of the outlet sectional reduction portion 82. The outlet end portion 33 connects the outlet sectional reduction portion 82 and the outlet opening 68 to each other and is formed to have a constant flow channel sectional area over the entire area in the axial direction Do. The flow channel sectional area (in other words, an inner diameter) of the outlet end portion 83 in the second embodiment is the same as the flow channel sectional area (in other words, an inner diameter) of the inner flow channel 73 of the inner pipe 65B.

As in the first embodiment, the inner pipe 65B is disposed at an interval on the inner side of the outer pipe 64B. The inner pipe 65B is formed in a tubular shape extending in the axial direction Do and forms, between the Outer pipe 64B and the inner pipe 65B, the film air flow channel 71 in which the film air Af flows. The end portion 65c of the inner pipe 65B on the axis upstream side Dou is disposed on the axis downstream side Dod of the inlet opening 67 of the outer pipe 64B. In addition, the end portion 65d of the inner pipe 65B on the axis downstream side Dod is disposed on the axis upstream side Dou of the outlet opening 68 of the outer pipe 64B. In the second embodiment, as in the first embodiment, a distance between the end portion 65d and the outlet opening 68 on the axis downstream side Dod is larger than a distance between the end portion 65c and the inlet opening 67 on the axis upstream side Dou in the axial direction Do.

The end portion 65d of the inner pipe 65B on the axis downstream side Dod according to the second embodiment is formed to overlap, in the axial direction Do, a part of the outlet sectional reduction portion 82 on the axis upstream side Dou. A chamfered portion 85 is formed at the end portion 65d of the inner pipe 65B on the axis downstream side Dod to be parallel to an inner wall surface 82a of the outlet sectional reduction portion 82. By forming the chamfered portion 85, the flow channel sectional area (in other words, the dimension S in the radial direction Dor) of the film air flow channel 71 is kept constant in the vicinity of the end portion 65d of the inner pipe 65B.

<<Effects>>

The outer pipe 64B of the premixed combustion burner 61B of the second embodiment described above includes the outlet sectional reduction portion 82 of which a flow channel sectional area gradually decreases toward the outlet opening 68.

In addition to the effects of the first embodiment described above, such a premixed combustion burner 61B can suppress the deceleration of a main flow flowed out from the inner flow channel 73 of the inner pipe 65B and the film air Af since the outlet sectional reduction portion 82 can gradually dec the flow channel sectional area of the outer pipe 64B. In addition, since the flow channel sectional area of the inner flow channel 73 and the flow channel sectional area of the outlet end portion 83 are the same, the main flow does not decelerate. For this reason, development of a vortex caused by a step formed at the end portion 65d of the inner pipe 65B on the axis downstream side Dod can be suppressed.

### First Modification Example of Embodiment

Next, a first modification example of the embodiment of the present disclosure will be described based on the drawings.

In the premixed combustion burners 61A and 61B of the first and second embodiments described above, a configuration where one type of fuel F containing hydrogen is jetted from the fuel jetting flow channel 74 and is mixed has been described. However, a premixed combustion burner 61C may be configured to be capable of premixing two or more types of fuels having different combustion speeds with the compressed air Acom. FIG. 8 is a sectional view of the premixed combustion burner of the first modification example of the embodiment of the present disclosure.

As shown in FIG. 3, in addition to the configuration of the premixed combustion burner 61A of the first embodiment described abo the premixed combustion burner 61C of the first modification example is configured to be capable of jetting a fuel (hereinafter, simply referred to as a low-reactivity fuel F2) having a combustion speed lower than the combustion speed of the fuel F, which is a high-reactivity fuel containing hydrogen. The premixed combustion burner 61C of the first modification example is configured to selectively jet the fuel F and the low-reactivity fuel F2, but may simultaneously jet the fuel F and the low-reactivity fuel F2. For example, a fuel containing methane can be given as an example of the low-reactivity fuel F2.

The fuel jetting device 60 of the first modification example includes, between the outer pipe 64 and the casing 62, a first fuel plenum 63A that stores the fuel F and a second fuel plenum 63B that stores the low-reactivity fuel F2.

The premixed combustion burner 61C includes the plurality of struts 66 that are formed at an interval in the axial direction Do. The premixed combustion burner 61C of the first modification example includes a first strut 66A and a second strut 66B that are disposed at an interval in the axial direction Do. In addition, in the first modification example, a plurality of first struts 66A are provided at an interval in the circumferential direction Doc. Similarly, a plurality of second struts 66B are provided at an interval in the circumferential direction Doc. The positions of the first struts 66A and the positions of the second struts 66B in the circumferential direction Doc may be the same.

The fuel jetting flow channel 74 that allows a fuel to be jetted from the outer side of the outer pipe 64 to the Inner side of the inner pipe 65 via the inside of the strut 66 is formed in the outer pipe 64, the strut 66, and the inner pipe 65. In the first modification example, a first fuel jetting flow channel 74A is formed in the outer pipe 64, the first strut 66A, and the inner pipe 65, and a second fuel jetting flow channel 74B is formed in the outer pipe 64, the second strut 66B, and the inner pipe 65. The first fuel jetting flow channel 74A allows the first fuel plenum 63A and the inner flow channel 73 of the inner pipe 65 to communicate with each other, and the second fuel jetting flow channel 74B allows the second fuel plenum 63B and the inner flow channel 73 of the inner pipe 65 to communicate with each other.

With the premixed combustion burner 61C of the first modification example, when using the low-reactivity fuel F2, the low-reactivity fuel F2 can be jetted from the axis upstream side of the fuel F and be mixed with the compressed air Acom since the second fuel jetting flow channel 74B is formed on the axis upstream side Dou of the first fuel jetting flow channel 74A. Therefore, since a distance from the second fuel jetting flow channel 74B to the outlet opening 68 can be made long, mixing of the compressed air Acom and the low-reactivity fuel F2 is promoted while suppressing flashback, and it is possible to reduce the amount of nitrogen oxide to be generated.

### Second Modification Example of Embodiment

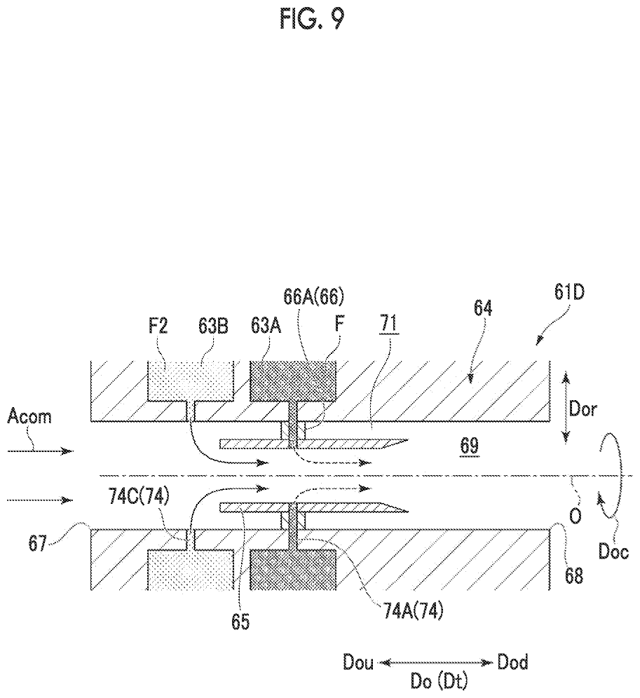

FIG. 9 is a sectional view of a premixed combustion burner of the second modification example of the embodiment of the present disclosure.

A case where the low-reactivity fuel F2 is jetted to the inner flow channel 73 of the inner pipe 65 through the second fuel jetting flow channel 74B has been described in the first modification example. However, a position where the second fuel jetting flow channel 74B is formed is not limited to the position of the first modification example. As shown in FIG. 9, for example, a second fuel jetting flow channel 74C through which the low-reactivity fuel F2 is jetted may be formed in the outer pipe 64 on the axis upstream side Dou of the inner pipe 65. The low-reactivity fuel F2 is jetted to the internal space 69 of the outer pipe 64 on the axis upstream side Dou of the inner pipe 65 through the second fuel jetting flow channel 74C. Since the low-reactivity fuel F2 is jetted through the second fuel jetting flow channel 74C of the second modification example from the outer side toward the inner side in the radial direction Dor toward the central axis O, a large portion of the jetted low-reactivity fuel F2 flows into the inner flow channel 73 of the inner pipe 65 and is mixed with the compressed air Acom. That is, the low-reactivity fuel F2 is rarely included in the film air Af flowing into the film air flow channel 71.

Therefore, as in the first modification example, with premixed combustion burner 61D of the second modification example, when using the low-reactivity fuel F2, the low-reactivity fuel F2 can be jetted from the axis upstream side Dou of the fuel F and be mixed with the compressed air Acom since the second fuel jetting flow channel 74C is formed on the axis upstream side Dou of the first fuel jetting flow channel 74A. Thus, since a distance from the second fuel jetting flow channel 74C to the outlet opening 68 can be made long, mixing of the compressed air Acom and the low-reactivity fuel F2 is promoted while suppressing flashback, and it is possible to reduce nitrogen oxide.

### Other Embodiment

Although the embodiments of the present disclosure have been described in detail with reference to the drawings hereinbefore, a specific configuration is not limited to the embodiments, and design changes or the like are also included without departing from the gist of the present disclosure.

For example, although the fuel jetting flow channel 74 is formed inside all of the struts 66 in the first and second embodiments and the first and second modification examples, which are the embodiments described above, the strut 66 in which the fuel jetting flow channel 74 is not formed may be included. In addition, the number of struts 66 is not limited to the number in the embodiments described above.

Although a case where the inner peripheral surface 64a of the outer pipe 64 is formed to have a sectional Circular shape and the inner pipe 65 is formed in a cylindrical shape in the fuel jetting device 60 according to the embodiment has been described, the shapes of the outer pipe 64 and the inner pipe 65 are not limited to the shapes. For example, the inner peripheral surface 64a of the outer pipe 64 may be formed to have a sectional polygonal shape, and the inner pipe 65 may be formed in a tubular shape having a polygonal section.

In addition, although a case where the tapered surface 72 is formed at the end portion 65d of the inner pipe 65 on the axis downstream side Dod is given as an example in the first embodiment and the first and second modification examples, the tapered surface 72 may be omitted.

Further, as in the second embodiment, the outlet sectional reduction portion 82 may be provided in the configurations of the first modification example and the second modification example described above. Further, although a case where two types of fuels having different combustion speeds are used is given as an example in the first modification example and the second modification example described above, three or more types of fuel jetting flow channels through which three or more types of fuels having different combustion speeds are jetted may be provided at intervals in the axial direction Do. In this case, as a fuel has a lower combustion speed, the fuel may be jetted from the axis upstream side Dou.

In addition, although the premixed combustion burners 61A to 61D used in the combustor 40 of the gas turbine 10 have been described in the embodiments, the premixed combustion burners according to the embodiments of the present disclosure are applicable to a combustor other than the gas turbine.

### APPENDIX

Some or all of the embodiments can be described as in the following appendix, but are not limited to the following.

(1) According to a first aspect, the premixed combustion burners 61A to 61D include the outer pipes 64 and 64B that have the inlet opening 67 on the first side in the axial direction Do in which the axis O extends and that have the outlet opening 68 on the second side in the axial direction Do, the inner pipes 65 and 65B that are formed in a tubular shape extending in the axial direction Do, that are disposed at an interval on the inner sides of the outer pipes 64 and 64B, and that form the film air flow channel 71, in which the film air Af flows, between the outer pipes 64 and 64B and the inner pipes 65 and 65B, and the strut 66 that extends inward from the [symbol] [symbol] of the outer pipes 64 and 64B and that supports the inner pipes 55 and 65B, in which the end portions of the inner pipes 65 and 65B on the first side are disposed on the second side of the inlet opening 67 of the outer pipes 64 and 64B, the end portions of the inner pipes 65 and 65B on the second side are disposed on the first side of the outlet opening 68 of the outer pipes 64 and 64B, and the fuel jetting flow channel 74 through which a fuel is jetted from the outer sides of the outer pipes 64 and 64B to the inner sides of the inner pipes 65 and 65B via the inside of the strut 66 is formed in the outer pipes 64 and 64B, the strut 66, and the inner pipes 65 and 65B.

In the premixed combustion burners 61A to 61D of the first aspect, the film air Af can flow along the inner wall surface 64a of the outer pipes 64 and 64B on the second side of the inner pipes 65 and 65B in the axial direction Do as the inner pipes 65 and 65B are disposed on the inner sides of the outer pipes 64 and 64B and form the film air flow channel 71. Accordingly, it can be suppressed that the fuel concentration of a flow in contact with the inner wall surface 64a of the outer pipes 64 and 64B rises. Therefore, even in a case where the flow speed of the flow in contact with the inner wall surface 64a of the outer pipes 64 and 64B falls below the Combustion speed, occurrence of flashback in which flame runs up the flow in contact with the inner wall surface 64a of the outer pipes 64 and 64B can be suppressed.

Further, in the premixed combustion burners 61A to 61D of the first aspect, since the end portion 65c of the inner pipes 65 and 65B on the first side Dou in the axial direction Do is disposed on the second side Dod of the inlet opening 67 of the outer pipes 64 and 64B in the axial direction Do, the compressed air Acom can be stably diverted to the film air flow channel 71 and the inner flow channel 73 without disturbing the flow of the compressed air Acom flowed in from the inlet opening 67 of the outer pipes 64 and 64B. In addition, since the end portion 65d of the inner pipes 65 and 65B on the second side Dod in the axial direction Do is disposed on the first side Dou of the outlet opening 68 of the outer pipes 64 and 64B in the axial direction Do, it can be suppressed that flame runs up a flow in contact with the [symbol] [symbol] of the inner pipes 65 and 65B.

Further, in the premixed combustion burners 61A to 610 of the first aspect, since the fuel jetting flow channel 74 is formed inside each of the outer pipes 64 and 64B, the strut 66, and the inner pipes 65 and 65B, the fuel F supplied to the fuel plenum 63 on the out ax sides of the outer pipes 64 and 64B or the Like can be jetted from the inner wall surface 65b of the inner pipes 65 and 65B toward an [symbol] to be a crossflow. Therefore, the fuel jetting flow channel 74 can be formed by effectively using the inside of the strut 66 that supports the inner pipes 65 and 65B without forming a pipe dedicated for guiding the fuel jetting flow channel 74.

(2) According to a second aspect, in the premixed combustion burners 61A to 61D according to the first aspect, the outer pipes 64 and 64B may be formed to have a length such that the fuel concentration of a flow in contact with the inner wall surface 64a of the outer pipes 64 and 64B, among a flow from the inlet opening 67 to the outlet opening 68 via the film air flow channel 71, is [symbol] [symbol] [symbol] [symbol] [symbol] having no possibility in which flame is maintained in an air flow.

By having the configuration as bed above, the fuel concentration of the flow in contact with the inner wall surface 64a of the outer pipes 64 and 64B is equal to or lower than the reference concentration, and it can be suppressed that flame reaches the flow in contact with the inner wall surface 64a of the outer pipes 64 and 64B. As a result, the occurrence of flashback in which flame runs up the flow in contact with the inner wall surface 64a of the outer pipes 64 and 64B can be suppressed.

(3) According to a third aspect, in the premixed combustion burners 61A to 61D according to the second aspect, the inner pipes 65 and 65B may be formed to have a length such that the fuel concentration of a flow in contact with the inner wall surface 65b of the inner pipes 65 and 65B, among a flow flowing out from the end portion 65d of the inner pipes 65 and 65B on the second side Dod, is equal to or lower than the reference concentration having no possibility in which flame is maintained in an air flow.

By having the configuration as described above, the fuel concentration of the flow in contact with the inner wall surface 65b of the inner pipes 65 and 65B is equal to ox lower than the reference concentration, and it can be suppressed that flame reaches the flow in contact with the inner wall surface 65b of the inner pipes 65 and 65B. As a result, the occurrence of flashback in which flame runs up the flow in contact with the inner wall surface 65b of the inner pipes 65 and 65B can be suppressed.

(4) According to a fourth aspect, the strut 66 of the premixed combustion burners 61A to 61D according to any one of the first to third aspects has a sectional vane shape.

By having the configuration as described above, since a flow channel resistance of the film air Af flowing in the axial direction Do in the film air flow channel 71 can be reduced, a flow speed decrease of the film air Af can be suppressed.

(5) According to a fifth aspect, the premixed combustion burner 61A, 61C, 61D according to any one of the first to fourth aspects includes, at the end portion 65d of the inner pipe 65 on the second side Dod, the tapered surface 72 that is inclined such that the flow channel sectional area of the inner flow channel 73 of the inner pipe 65 increases toward the second side Dod.

By providing such a tapered surface 72, for example, in a case where it is necessary to provide the tapered surface 72 at the end portion 65d on the second side Dod in the axial direction Do for convenience of preparing the inner pipe 65, the flow channel sectional area of the film air flow channel 71 increases, the static pressure of the film air Af is recovered, and a flow speed decrease can be suppressed.

(6) According to a sixth aspect, the fuel F of the premixed combustion burners 61A to 61D of any one of the first to fifth aspects contains a hydrogen gas.

Even in a case where a high-reactivity fuel that contains the hydrogen gas as described above and that has a high combustion speed is used, the occurrence of flashback can be effectively suppressed.

(7) According to a seventh aspect, the outer pipe 64B of the premixed combustion burner 61B according to any one of the first to sixth aspects includes the outlet sectional reduction portion 82 that gradually decreases the flow channel sectional area toward the outlet opening 68.

By having the configuration as described above, the deceleration of a main flow flowed out from the inner flow channel 73 of the inner pipe 65B and the film air Af can be suppressed since the outlet sectional reduction portion 82 can gradually decrease the flow channel sectional area of the outer pipe 64B. In addition, since the flow channel sectional area of the inner flow channel 73 and the flow channel sectional area of the outlet and portion 83 are the same, the main flow does not decelerate. For this reason, development of a vortex caused by a step formed at the end portion 65d of the inner pipe 65B on the second side Dod in the axial direction Do can be suppressed.

(8) According to an eighth aspect, the premixed combustion burner 61C of any one of the first to seventh aspects includes the plurality of struts 66 (66A and 66B) formed at an interval in the axial direction Do, the plurality of fuel jetting flow channels 74 (74A and 74B) formed at an interval in the axial direction Do are provided in the outer pipe 64, the plurality of struts 66 disposed at the interval in the axial direction Do, and the inner pipe 65, and as the fuel jetting flow channel 74 is disposed closer to the first side in the axial direction Do, the other fuel F2 having a lower combustion speed is jetted.

(9) According to a ninth aspect, in the premixed combustion burner 61D according to any one of the first to seventh aspects, the second fuel jetting flow channel 74C through which the other fuel F2 having a combustion speed lower than a combustion speed of the fuel F is jetted to the inner side of the outer pipe 64 is formed in the outer pipe 64 on the first side Dou of the inner pipe 65 in the axial direction Do.

According to the eighth and ninth aspects, as the fuel jetting flow channel 74 is formed also on the first side of the fuel jetting flow channel 74 in the axial direction Do, when the other fuel F2 having a low combustion speed is used, the other fuel F2 can be jetted further from the first side Dou to be mixed with the compressed air Acom. Therefore, since a distance from the fuel jetting flow channel 74, through which the other fuel F2 is jetted, to the outlet opening 68 can be made long, mixing of the compressed air Acom and the other fuel F2 is promoted while suppressing flashback, and it is possible to reduce the amount of nitrogen oxide to be generated.

(10) According to a tenth aspect, the fuel jetting device 60 includes the plurality of premixed combustion burners 61A to 61D, the casing 62 that supports the plurality of premixed combustion burners 61A to 61D, and the fuel plenum 63 that is provided in the casing 62 and on the outer side of the outer pipe 64.

Since flashback can be suppressed by including the premixed combustion burners 61A to 61D described above, the occurrence of damage to the fuel jetting device 60 can be suppressed.

(11) According to an eleventh aspect, the gas turbine 10 includes the compressor 20 that generates a compressed air, the combustor 40 that has the fuel jetting device 60 according to the tenth aspect and the combustion cylinder 50 which generates the combustion gas G by combusting the mixture Gm jetted from the fuel jetting device 60, and the turbine 30 that is driven by the combustion gas G generated by the combustor 40.

As the gas turbine 10 includes the fuel jetting device 60 described above, the reliability of the gas turbine 10 can be improved.

### INDUSTRIAL APPLICABILITY

According to the aspect, the occurrence of flashback can be prevented.

### REFERENCE SIGNS LIST

10 gas turbine
11 gas turbine rotor
15 gas turbine casing
16 intermediate casing
20 compressor
21 compressor rotor.
22 rotor shaft.
23 rotor vane row
25 compressor casing
26 stator vane row
30 turbine.
31 turbine rotor
32 rotor shaft
33 rotor vane row
35 turbine casing
36 stator vane row
40 combustor
50 combustion cylinder
60 fuel jetting device
61A, 61B, 61C, 61D premixed combustion burner
52 casing
63 fuel plenum
63A first fuel plenum
63B second fuel plenum
64, 64B outer pipe
64a inner peripheral surface
65, 65B inner pipe
65a outer peripheral surface
65b inner peripheral surface.
65c end portion
65d end portion
66 strut
66A first strut
66B second strut
66a first surface
66b second surface
67 inlet opening
68 outlet opening
69 internal space
71 film air flow channel
72 tapered surface
73 inner flow channel
74 fuel jetting flow channel.
74A first fuel jetting flow channel
74B, 74C second fuel jetting flow channel
81 outer pipe main body
82 outlet sectional reduction portion
83 Outlet end portion
84 internal space
85 chamfered portion

1. A premixed combustion burner comprising:
an outer pipe that has an inlet opening on a first side in an axial direction in which an axis extends and an outlet opening on a second side in the axial direction;
an inner pipe that is formed in a tubular shape extending in the axial direction, that is disposed at an interval on an inner side of the outer pipe, and that forms a film air flow channel, in which film air flows, between the outer pipe and the inner pipe; and
a strut that extends inward from an inner wall surface of the outer pipe and that supports the inner pipe,
wherein an end portion of the inner pipe on the first side is disposed on the second side of the inlet opening of the outer pipe,
an end portion of the inner pipe on the second side is disposed on the first side of the outlet opening of the outer pipe, and
a fuel jetting flow channel, through which a fuel is jetted from an outer side of the outer pipe to an inner side of the inner pipe via an inside of the strut, is formed in the outer pipe, the strut, and the inner pipe.

2. The premixed combustion burner according to claim 1,
wherein the outer pipe is formed to have a length such that a fuel concentration of a flow in contact with the inner wall surface of the outer pipe, among a flow from the inlet opening to the outlet opening via the film air flow channel, is a fuel concentration that is equal to or lower than a reference concentration having no possibility in which flame is maintained in an air flow.

3. The premixed combustion burner according to claim 2,
wherein the inner pipe is formed to have a length such that a fuel concentration of a flow in contact with an inner wall surface of the inner pipe, among a flow flowing out from the end portion of the inner pipe on the second side, is equal to or lower than a reference concentration having no possibility in which flame is maintained in an air flow.

4. The premixed combustion burner according to claim 1,
wherein the strut has a sectional vane shape.

5. The premixed combustion burner according to claim 1, further comprising:
a tapered surface that is inclined such that a flow channel sectional area of the inner pipe increases toward the second side, at the end portion of the inner pipe on the second side.

6. The premixed combustion burner according to claim 1,
wherein the fuel contains a hydrogen gas.

7. The premixed combustion burner according to claim 1,
wherein the outer pipe includes an outlet sectional reduction portion that gradually decreases a flow channel sectional area toward the outlet opening.

8. The premixed combustion burner according to claim 1, further comprising:
a plurality of the struts that are formed at an interval in the axial direction,
wherein a plurality of the fuel jetting flow channels that are formed at an interval in the axial direction are provided in the outer pipe, the plurality of struts disposed at the interval in the axial direction, and the inner pipe, and
as the fuel jetting flow channels are disposed closer to the first side in the axial direction, another fuel having a lower combustion speed is jetted.

9. The premixed combustion burner according to claim 1,
wherein a second fuel jetting flow channel, through which another fuel having a combustion speed lower than a combustion speed of the fuel is jetted to the inner side of the outer pipe, is formed in the outer pipe on the first side of the inner pipe in the axial direction.

10. A fuel jetting device comprising:
a plurality of premixed combustion burners according to claim 1;
a casing that supports the plurality of premixed combustion burners; and
a fuel plenum that is provided in the casing and on the outer side of the outer pipe.

11. A gas turbine comprising:
a compressor that generates a compressed air;
a combustor that has the fuel jetting device according to claim 10 and a combustion cylinder which generates a combustion gas by combusting a mixture jetted from the fuel jetting device; and
a turbine that is driven by the combustion gas generated by the combustor.
